(19) United States
(12) Patent Application Publication
(10) Pub. No.: US 2025/0356286 A1
(43) Pub. Date: Nov. 20, 2025

(54) CATERING AUTOMATION DEVICE, MANAGEMENT SYSTEMS AND METHODS

(71) Applicant: Beijing ZEEWAY-Technology Ltd, Beijing (CN)

(72) Inventors: Mengyi Zhu, Beijing (CN); Fumei Duan, Beijing (CN); Renlong Zhang, Beijing (CN); Haijin Xu, Beijing (CN); Musheng Shen, Beijing (CN); Yunlong Xu, Beijing (CN)

(73) Assignee: Beijing ZEEWAY-Technology Ltd, Beijing (CN)

(21) Appl. No.: 18/955,948

(22) Filed: Nov. 21, 2024

(30) Foreign Application Priority Data
Nov. 22, 2023 (CN) 2023115664837

(51) Int. Cl. G06Q 10/0631; G06F 9/54; G06Q 10/0875; G06Q 30/0601

(52) U.S. Cl. CPC G06Q 10/06315; G06F 9/546; G06Q 10/0875; G06Q 30/0603

(57) ABSTRACT

The present invention discloses a management method for catering automation device, comprising: connecting one or more catering automation devices to a cloud platform; the cloud platform receiving orders and distributing relevant formula information, including raw material codes and quantities, to one or more catering automation devices based on information of the orders; wherein, the cloud platform obtains raw material codes and raw material quantities from the order related recipe according to information of the order, and distributes them to order related devices, and the devices each drives corresponding material bins to dispense required raw material quantities according to the raw material codes and the raw material quantities. The present invention eliminates the need for data center planning and IT managing for catering enterprises, institutions, and individual devices, and makes them highly configurable.

### TECHNICAL FIELD

The present invention relates to a field of catering automation, and more specifically, to a management method for catering automation device. The present invention also relates to a management system for catering automation devices, a catering automation device using the management method and the management system.

### BACKGROUND

In today's era of rapid technological development, decrease in machine costs and increase in labor costs have led to a gradual rise of catering automation. The catering automation is a newly emerging field, and various catering automation devices, such as beverage automation preparation devices and food automation preparation devices have emerged. However, if each device needs to manage both recipes and orders, as well as drive the device to prepare beverages or foods, configuration requirements for hardware of the device are high, and maintenance investment for a single device is large. In case of a large number of devices, the device investment and maintenance costs are enormous.

Therefore, there is a need for a more scientific and effective device management method, system, and device suitable for catering automation.

### SUMMARY

The purpose of the present invention is to solve or at least partially alleviate the above-mentioned problems by providing a catering automation device, system, management method.

According to one aspect of the present invention, there is provided a management method for catering automation device, comprising:
connecting one or more catering automation devices to a cloud platform;
the cloud platform receiving orders and distributing relevant formula information, including raw material codes and quantities, to one or more catering automation devices based on information of the orders;
wherein, the cloud platform obtains raw material codes and raw material quantities from the order related recipe according to information of the order, and distributes them to order related devices, and the devices each drives corresponding material bins to dispense required raw material quantities according to the raw material codes and the raw material quantities.

Preferably, a first message middleware and a second message middleware connected to the device, and an order management database are provided on the cloud platform, and after receiving the orders, the order management database sends them to the second message middleware for asynchronous queuing, and sends a current order to the first message middleware for processing, obtaining the raw material codes and quantities of the order related formulas, and sending them downstream to the order related devices.

Preferably, a recipe management is provided on the cloud platform and set with multi-level caching, and the first message middleware obtains the raw material codes and raw material quantities of order related recipes through the multi-level caching.

Preferably, each catering automation device comprises an upper computer, a lower computer, bins, and a bin driving device, the raw material codes and quantities of the order related recipes are sent from the cloud platform to the upper computer, and the upper computer sends instructions to the lower computers according to the raw material codes and quantities of the order related recipes, the lower computer receives the instructions and drives the bin driving devices of the catering automation device corresponding to the raw material codes of the recipe to dispense the corresponding raw material quantities to a predetermined container according to the instructions.

Preferably, the first message middleware is a broker and the second message middleware is a Rocketmq.

Preferably, the cloud platform further comprises a store management database, so that the cloud platform allows adding or selecting stores in the store management database, and each catering automation device is classified according to the selected store.

Preferably, the cloud platform further comprises a merchant management database, so that the cloud platform allows adding or selecting merchants in the merchant management database, and the selected stores are classified according to the selected merchants.

Preferably, the cloud platform is connected to each catering automation device through the Internet of Things.

Preferably, each catering automation device is authorized by the cloud platform to access the cloud platform.

Preferably, the device related basic information includes working status, operation status, initialization status, cleaning status, and component usage time of each of the device.

Preferably, the order management system comprises a local order system and a network order system, and the cloud platform is compatible with the network order management system.

Preferably, the raw material bins of the catering automation device are equipped with a material monitoring device for monitoring amount of material, recording status of the bin, and uploading it to the cloud platform.

Preferably, when the amount of material is below a threshold, or after the raw materials existing in the bins for a period of time, the material monitoring device sends a material addition prompt or a material expiration prompt to the cloud platform and/or a beverage and/or dish automated catering device.

According to another aspect of the present invention, there is provided a management system for catering automation device, comprising:
a recipe management database, capable of being configured and input raw material codes and quantities related to beverages and/or dishes and ingredients, to form recipes for beverages and/or dishes;
a device management database, capable of being input device codes, bin codes of the device, and device related information, and being set corresponding bin codes and raw material codes of the device;
wherein, the management system for catering automation devices is capable of being connected to the order management system, which receives orders including device codes, beverage and/or dish and recipe information;
wherein, the management system for catering automation device is capable of being connected to one or more catering automation devices, and each device is set corresponding to its device code, including a bin set corresponding to the raw material codes, which contains the corresponding raw materials; and
wherein, the cloud platform obtains the raw material codes and raw material quantities of the order related recipe according to the order information, and distributes them to the order related device, which drives the corresponding material bins to dispense the required raw material quantities according to the raw material codes and raw material quantities.

According to another aspect of the present invention, there is provided a catering automation device comprising:
storage bins, used to hold raw materials required for preparing beverages and/or dishes;
wherein the catering automation device uses the management system for catering automation device.

The catering automation device, system, and management method of the present invention enable catering enterprises and institutions to no longer need to plan their own data centers or spend time or money on IT management unrelated to their main business, thereby saving time, energy, and money that can be invested in operation of the enterprise. The same applies to individual users. Moreover, the method and system of the present invention are highly configurable, allowing users to dynamically expand and configure them as needed. Therefore, it has pioneering significance for the catering industry.

### BRIEF DESCRIPTION OF FIGURES

Other features, objectives, and advantages of the present invention will become more apparent from reading detailed description of non-limiting embodiments with reference to the following figures:

FIG. 1 is a flowchart illustrating an embodiment of a management method and system for catering automation devices according to the present invention, mainly demonstrating an overall application of the present invention;

FIG. 2 is a flowchart illustrating another embodiment of management method and system for catering automation devices according to the present invention, mainly showing basic architecture of a cloud platform;

FIG. 3 is a flowchart illustrating another embodiment of a management method and system for catering automation devices according to the present invention, mainly showing an optimized architecture of a cloud platform;

FIG. 4 is a flowchart illustrating another embodiment of a management method and system for catering automation devices according to the present invention, mainly showing basic architecture of a device;

FIG. 5 is a basic information configuration diagram of device management database of a management method and system for catering automation devices according to the present invention;

FIG. 6 is a schematic diagram of an implementation of device management database of a catering management system according to the present invention.

### DETAILED EMBODIMENTS

A further detailed explanation of the present application will be provided in conjunction with the accompanying drawings and embodiments below. It can be understood that specific embodiments described here are only used to explain the relevant invention, and not to limit the invention. Additionally, it should be noted that for ease of description, only parts related to the invention are shown in the accompanying drawings.

In figures, identical or similar elements are labeled with the same reference number, and only the first digit to the left of the reference number is changed to distinguish them from each other.

A management method and system of catering automation devices of the present invention is a comprehensive management method and system for devices, device related order systems, recipes, stores, and merchants in catering field, which enables catering enterprises and institutions to no longer need to provide their own data centers or spend time and money on IT management unrelated to their main business, thereby saving time, energy, and money to be invested in operation of the enterprises. The same applies to individual users. Moreover, the method and system of the present invention are highly configurable, allowing users to dynamically expand and configure as needed. Therefore, it has pioneering significance for catering industry.

For sake of simplicity, following detailed embodiments are based on description and explanation of principles and specific embodiments of the present invention in field of beverage preparation. However, the present invention is also applicable to the field of dish configuration in restaurants and other establishments, and will not be described in detail here.

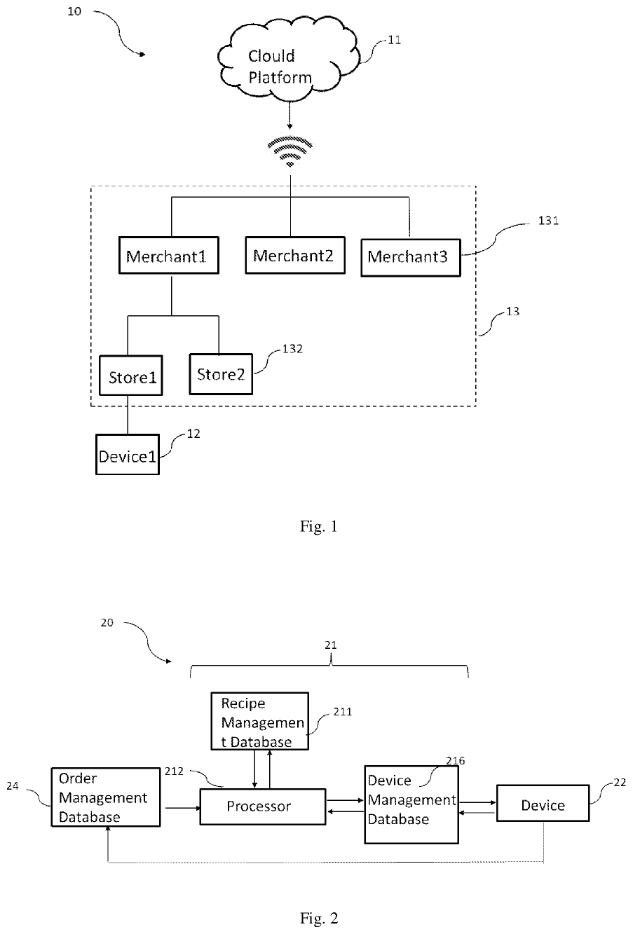

FIG. 1 is a flowchart illustrating an embodiment of a management method and system for catering automation devices according to the present invention, mainly demonstrating an overall application of the present invention. The flowchart of the application is generally indicated by the reference number 10, which shows that the management method and system of the present invention can be directly applied to a device 12 from a cloud platform 11 without a part indicated by a middle dashed box 13, and can also manage different merchants 131, different stores 132 of each merchant 131, and each device of each store 132 indicated in the middle dashed box 13 through the cloud platform 11. That is to say, the management method and system of the present invention are not only applicable to management of a single device, but also to the comprehensive management of different merchants.

The cloud platform 11 is connected to each catering automation device 12 through the Internet of Things, and each catering automation device 12 is authorized by the cloud platform 11 to access the cloud platform 11.

FIG. 2 is a flowchart illustrating another embodiment of management method and system for catering automation devices according to the present invention, mainly showing basic architecture of a cloud platform. The flowchart is generally indicated with a reference number 20, showing architecture of a cloud platform 21 and devices 22 and an order management system 24 connected to the cloud platform 21.

Referring to FIG. 2, basic principle of a management method and system for catering automation device according to the present invention will be explained. In FIG. 2, for sake of simplicity, the cloud platform 21 is directly connected to the device 22, omitting situations of device management according to different merchants and stores shown in FIG. 1.

As an example showed in FIG. 2, the management method for catering automation device of the present invention includes following steps:
setting up a recipe management database 211 for beverages and/or dishes on the cloud platform 21, and configuring and input recipes, including ingredient codes and quantities;
setting up a device management database 216 on the cloud platform 21, inputting device codes, material bin codes for the devices, and device related information, in which material bin codes are set corresponding to raw material codes;
connecting the order management system 24 to the cloud platform 21 to receive orders that include device codes, beverage and/or dish information, and recipe information;
connecting one or more catering automation devices 22 to the cloud platform 21, with each device corresponding to a device code, including a bin set corresponding to the raw material codes, which contains corresponding raw materials,
wherein, the cloud platform 21 processes orders through the processor 212, obtains the raw material codes and quantities of the order related recipes based on the order information, and distributes them to the devices 22 related to the order. Each of the devices 22 drives the corresponding material bins to dispense required quantities of raw materials based on the raw material codes and quantities.

Therefore, the corresponding management system (cloud platform 21) for catering automation device according to the present invention includes:
a recipe management database 211, capable of being configured and input raw material codes and quantities related to beverages and/or dishes and ingredients, to form recipes for beverages and/or dishes;
a device management database 216, capable of being input device codes, bin codes of the device, and device related information, and being set corresponding bin codes and raw material codes of the device;
wherein, the management system for catering automation devices is capable of being connected to the order management system 24, which receives orders including device codes, beverage and/or dish and recipe information;
wherein, the management system for catering automation device is capable of being connected to one or more catering automation devices 22, and each of devices 22 is set corresponding to its device code, including a bin set corresponding to the raw material codes, which contains the corresponding raw materials; and
wherein, the order management system 24 sends the order information to the cloud platform processor 212, which obtains the raw material codes and quantities of the order related recipe and distributes them to the order related device 22, which drives the corresponding material bins to dispense the required raw material quantities according to the raw material codes and raw material quantities.

The order management system 24 includes a local order system and a network order system, and the cloud platform 21 is compatible with the network order management system.

It can be seen that using the management method and system for catering automation device according to the present invention, the catering automation device no longer requires to be provided its own data center, and catering enterprises and institutions that own the devices do not need to spend time and money on IT management unrelated to their main business, or even do not need to be provided an order management system. Therefore, time, energy, and money can be saved and invested in operation of the enterprise. The device management method and the system for catering automation device according to the present invention are also applicable to individual users.

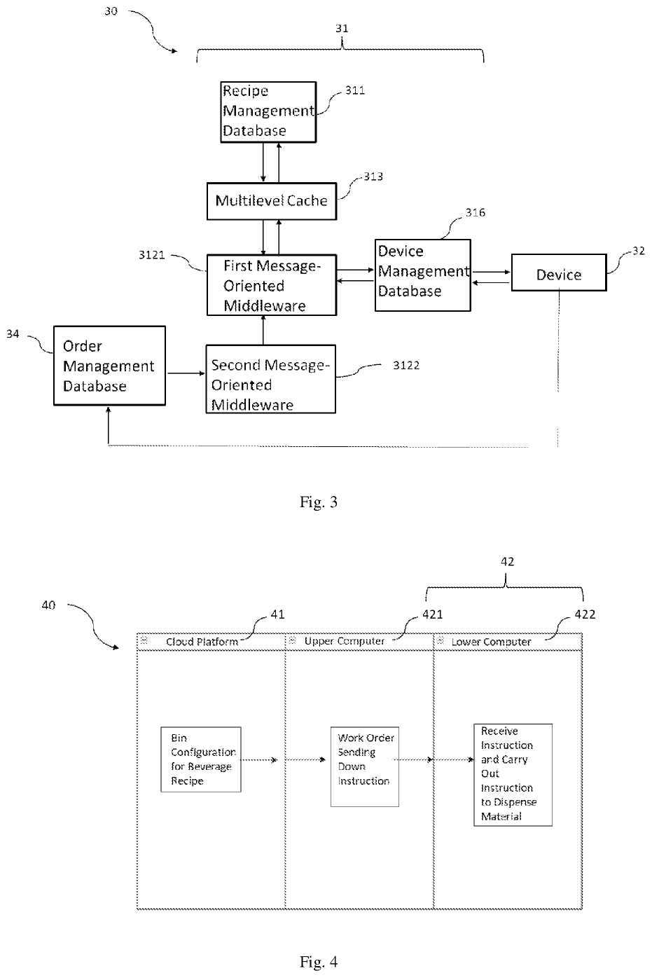

FIG. 3 is a flowchart illustrating another embodiment of a management method and system for catering automation devices according to the present invention, mainly showing an optimized architecture of a cloud platform.

Considering that many devices 22 may be connected to the cloud platform 21, in order to ensure stability and efficiency of an entire system, and thus ensure performance of the entire system, the catering automation equipment management method and system according to the present invention can be further optimized based on FIG. 2, and the optimized architecture example is shown in FIG. 3.

Referring specifically to FIG. 3, the processor 212 in FIG. 2 is replaced by a first message middleware 3121 and a second message middleware 3122. When receiving an order, the order management system 34 sends it to the second message middleware 3122 for asynchronous queuing, and sends a current order to the first message middleware 3121 for processing. The first message middleware 3121 obtains raw material codes and quantities of an order related recipe, and distributes it to an order related device 32 according to information of the device in the device management database 316. Providing of the first message middleware 3121 and the second message middleware 3122 enables asynchronously queuing and processing of orders. The first message middleware 3121 only processes the current order, avoiding system congestion caused by too many orders. There is no need to improve configuration of the first message middleware 3121, which ensures stability and throughput of the entire system at a lower system cost. The first message middleware can be, for example, a broker, and the second message middleware can be, for example, a Rocketmq.

Access method to the recipe management database of the management method and system for catering automation device of the present invention can be further optimized. Preferably, there are multi-level caches 313 on the cloud platform provided on the cloud platform for the recipe management database of the corresponding beverage and/or dish recipes. The first message middleware 3121 obtains the raw material codes and quantities of the order related recipes through the multi-level caches 313. The providing of multi-level caches 313 can achieve to retrieve query data not, for example, not directly from the database, but from the cache, thereby reducing congestion pressure of the database and improving performances of the system.

The multi-level caches 313 can be any levels of caches, including at least the first level cache. In the embodiment shown in FIG. 2, the processor 212 can also access the recipe management database 211 through multi-level caches to obtain the raw material codes and quantities of the order related recipes.

Providing of the first message middleware 3121 and the second message middleware 3122, as well as providing the multi-level caches in FIG. 3, can be used both or either of them, which are within the scope of protection of the present invention.

The embodiments shown in FIGS. 1 to 3 use an IoT real-time database to store data.

FIG. 4 is a flowchart showing another embodiment of the management method and system for catering automation devices according to the present invention, mainly showing basic architecture of one of the devices.

Referring specifically to FIG. 4, as an example the beverage automation equipment 42 includes an upper computer 421, a lower computer 422, bins, and a driving device for bins (not shown). A cloud platform 41 sends raw material codes and quantities of an order related recipe to a device management database. The device management database corresponds the raw material codes with the corresponding device codes in the recipe to the corresponding bins of the device, generates bin configuration for the beverage recipe, and distributes the bin configuration for the beverage recipe to the upper computer 421. The upper computer 421 sends instructions (i.e. generates work orders and sends them) to the lower computer 422 according to the raw material codes and quantities (bin configuration for the beverage recipe) of the order related recipes. The lower computer 422 receives the instructions (work orders) and drives the driving device for bins of the beverage automation device corresponding to the raw material codes of the recipe to dispense the corresponding quantities of the raw materials to the predetermined containers according to the instructions.

A local order system is usually provided in the upper computer 421 of the beverage automation device 42, such as a touch screen. The local order system receives local orders through the touch screen and sends them to the second message middleware of the cloud platform for order queuing. When in current position, the order is processed in the first message middleware. The lower computer 422, such as a programmable logic controller (PLC), can receive instructions from the upper computer 421 to drive the driving devices for bins to dispense the corresponding quantities of the raw materials to the predetermined containers.

In this way, the beverage automation device using the management method and system for catering automation devices according to the present invention does not need to process orders locally, so high performance and efficiency requirements of the system can be achieved even using low-cost system configuration.

The basic architecture of the device in this embodiment is also applicable to food automation device, and will not be repeated here.

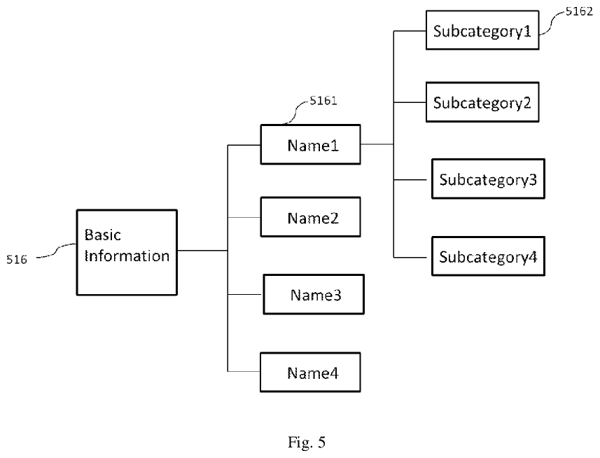

FIG. 5 is a basic information configuration diagram of device management database of a management method and system for catering automation devices according to the present invention.

Before configuring the information of the recipe management database, the device management database and so on, basic information 516 for an upper level or for common uses can be configured. The basic information 516 for the upper level or common uses includes names 5161, subclasses 5162 and so on. Names 5161 include, but are not limited to beverage devices, dish devices and so on. Subclasses 5161 include, but are not limited to, for example, milk tea machines, yogurt machines and so on. The basic information that requires to be identified by computers includes Chinese characters and codes or numbers. The basic information 516 is used for configuring information in the recipe management database, merchant management database, user management database, device management database and so on. When inputting and configuring information in the recipe management database, merchant management database, user management database, device management database and so on, users can directly select the already configured basic information 516 for use, and only input and configure new or personalized information.

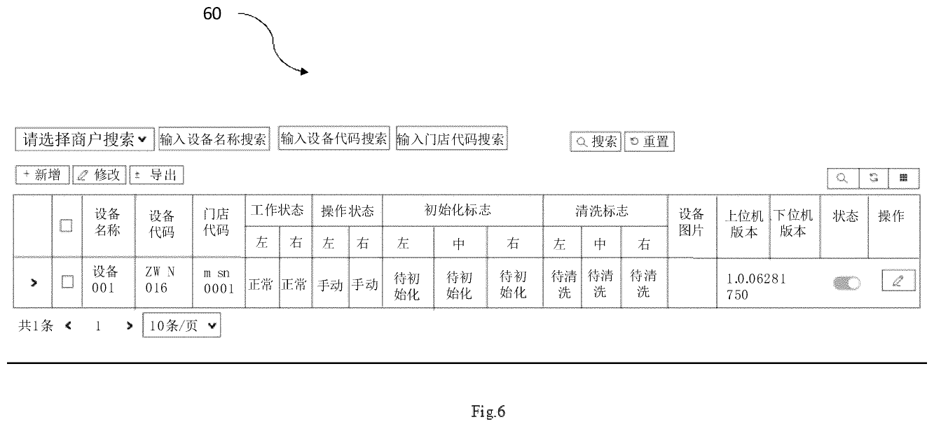

FIG. 6 is a schematic diagram of an implementation of the device management database of the catering management system according to the present invention. The device management database in the figure is shown in form of a web-based device management card 60, which includes functions for adding, modifying, and exporting. Users can input device names, input or select device codes, input or select corresponding stores, input or select work status, operation status, initialization flag, cleaning flag, upper computer version, etc. through the function of adding. Users can modify the input device names and related information through the function of modifying. After configuring the device management database, information in the device management database can also be exported.

The device management card 60 can also add a function of merchant search, store search, store code search, device name search, and device code search to ensure that the device does not exist in the device management database before adding it.

Optionally, the device management database is not limited to the form of device management card 60, and can also be implemented in forms of dialog boxes, drop-down lists and so on.

The device management database in the management method and system for the catering automation devices of the present invention is not limited to the specific implementation in FIG. 6, and other ways that can achieve the functions and principles of the present invention are within the scope of protection of the present invention.

The bins for raw materials of the catering automation device can be equipped with a material monitoring device to monitor amount of materials, record status of the bins, and upload them to the cloud platform. In this way, the management system and method for catering automation device of the present invention can also achieve monitoring and managing of the bins. When amount of raw materials in the bins is below a threshold, or after the raw materials exist in the bins for a long period of time, the material monitoring device can send material addition or expiration prompts to the cloud platform and/or beverage and/or dish preparation device.

The present invention also relates to a catering automation device, comprising:
storage bins, used to hold raw materials required for preparing beverages and/or dishes;
wherein, the catering automation device uses the management system for catering automation device.

The present invention also relates to a computing device, on which a computer program is installed. When the computer program is executed, the computing device executes the management method for catering automation devices of the present invention or implements the management system for catering automation devices of the present invention.

The present invention further relates to a computer-readable storage medium, on which a computer program is stored. When the computer program is executed by the computer, the management method for catering automation device of the present invention or the management system for catering automation device of the present invention is implemented.

The management method or system for catering automation devices of the present invention can also obtain more data, such as beverage sales, best-selling beverages, consumption of raw materials and so on, thereby providing data analysis and decision support to assist merchants in data analysis and decision support. By analyzing customer's consumption behaviors, beverage and/or dish sales data, merchants can adjust their business strategies in a timely manner, optimize recipe combinations, and improve management and profitability.

The above description is only preferred embodiments of the present application and explanation of technical principles applied. Persons of the field should understand that scope of the invention referred to in this application is not limited to specific combination of above technical features, but should also cover other technical solutions formed by any combination of the above technical features or their equivalent features without departing from concept the invention, for example, a technical solution formed by replacing the above features with (but not limited to) technical features with similar functions disclosed in this application.

What is claimed is:

1. A management method for catering automation device, comprising:
connecting one or more catering automation devices to a cloud platform; the cloud platform receiving orders and distributing relevant formula information, including raw material codes and quantities, to one or more catering automation devices based on information of the orders;
wherein, the cloud platform obtains raw material codes and raw material quantities from the order related recipe according to information of the order, and distributes them to order related devices, and the devices each drives corresponding material bins to dispense required raw material quantities according to the raw material codes and the raw material quantities.

2. The management method for catering automation device according to claim 1, wherein a first message middleware and a second message middleware connected to the device, and an order management database are provided on the cloud platform, and after receiving the orders, the order management database sends them to the second message middleware for asynchronous queuing, and sends a current order to the first message middleware for processing, obtaining the raw material codes and quantities of the order related formulas, and sending them downstream to the order related devices.

3. The management method for catering automation device according to claim 2, wherein a recipe management is provided on the cloud platform and set with multi-level caching, and the first message middleware obtains the raw material codes and raw material quantities of order related recipes through the multi-level caching.

4. The management method for catering automation device according to claim 3, wherein each catering automation device comprises an upper computer, a lower computer, bins, and a bin driving device, the raw material codes and quantities of the order related recipes are sent from the cloud platform to the upper computer, and the upper computer sends instructions to the lower computers according to the raw material codes and quantities of the order related recipes, the lower computer receives the instructions and drives the bin driving devices of the catering automation device corresponding to the raw material codes of the recipe to dispense the corresponding raw material quantities to a predetermined container according to the instructions.

5. The management method for catering automation device according to claim 2, wherein the first message middleware is a broker and the second message middleware is a Rocketmq.

6. The management method for catering automation device according to claim 1, wherein the cloud platform further comprises a store management database, so that the cloud platform allows adding or selecting stores in the store management database, and each catering automation device is classified according to the selected store.

7. The management method for catering automation device according to claim 6, wherein the cloud platform further comprises a merchant management database, so that the cloud platform allows adding or selecting merchants in the merchant management database, and the selected stores are classified according to the selected merchants.

8. The management method for catering automation device according to claim 1, wherein the cloud platform is connected to each catering automation device through the Internet of Things.

9. The management method for catering automation device according to claim 1, wherein each catering automation device is authorized by the cloud platform to access the cloud platform.

10. The management method for catering automation device according to claim 1, wherein the device related basic information includes working status, operation status, initialization status, cleaning status, and component usage time of each of the device.

11. The management method for catering automation device according to claim 1, wherein the order management system comprises a local order system and a network order system, and the cloud platform is compatible with the network order management system.

12. The management method for catering automation device according to claim 1, wherein the raw material bins of the catering automation device are equipped with a material monitoring device for monitoring amount of material, recording status of the bin, and uploading it to the cloud platform.

13. The management method for catering automation device according to claim 12, wherein when the amount of material is below a threshold, or after the raw materials existing in the bins for a period of time, the material monitoring device sends a material addition prompt or a material expiration prompt to the cloud platform and/or a beverage and/or dish automated catering device.

14. A management system for catering automation device, comprising:
a recipe management database, capable of being configured and input raw material codes and quantities related to beverages and/or dishes and ingredients, to form recipes for beverages and/or dishes;
a device management database, capable of being input device codes, bin codes of the device, and device related information, and being set corresponding bin codes and raw material codes of the device;
wherein, the management system for catering automation devices is capable of being connected to the order management system, which receives orders including device codes, beverage and/or dish and recipe information;
wherein, the management system for catering automation device is capable of being connected to one or more catering automation devices, and each device is set corresponding to its device code, including a bin set corresponding to the raw material codes, which contains the corresponding raw materials; and
wherein, the cloud platform obtains the raw material codes and raw material quantities of the order related recipe according to the order information, and distributes them to the order related device, which drives the corresponding material bins to dispense the required raw material quantities according to the raw material codes and raw material quantities.

15. A catering automation device, comprising:
storage bins, used to hold raw materials required for preparing beverages and/or dishes;
wherein the catering automation device uses the management system for catering automation device according to claim 14.
